(19) United States
(12) Patent Application Publication
(10) Pub. No.: US 2017/0176667 A1
(43) Pub. Date: Jun. 22, 2017

(54) LIGHT GUIDE PLATE, BACKLIGHT MODULE AND DISPLAY DEVICE

(71) Applicants: Shanghai Tianma Micro-electronics Co., Ltd., Shanghai (CN); Tianma Micro-electronics Co., Ltd., Shenzhen (CN)

(72) Inventors: SHUWEN ZHANG, Shanghai (CN); XUHUI LI, Shanghai (CN); YUAN LI, Shanghai (CN); DONG LIU, Shanghai (CN)

(73) Assignees: Shanghai Tianma Micro-electronics Co., Ltd.; Tianma Micro-electronics Co., Ltd.

(21) Appl. No.: 15/075,259

(22) Filed: Mar. 21, 2016

(30) Foreign Application Priority Data
Dec. 18, 2015 (CN) 2015-10958671.3

(51) Int. Cl. F21V 8/00

(52) U.S. Cl. CPC G02B 6/0055

(57) ABSTRACT

A light guide plate, a backlight module and a display device are provided. The light guide plate comprises at least one light incident surface having at least one first light incident surface, a light emitting surface adjacent to the light incident surface, and a plurality of lateral faces adjacent to the light emitting surface. At least one lateral face adjacent to the light emitting surface is disposed with a plurality of reflective microstructures.

### CROSS-REFERENCES TO RELATED APPLICATIONS

This application claims the priority of Chinese patent application No. CN201510958671.3, filed on Dec. 18, 2015, the entire content of which is incorporated herein by reference.

### FIELD OF THE DISCLOSURE

The present disclosure relates to the field of display technology and, more particularly, relates to a light guide plate, a backlight module and a corresponding display device.

### BACKGROUND

With the development of display technologies, various displays are emerging and becoming hot research topics. In particular, liquid crystal displays (LCDs) have been widely used and seen a tremendous development because of the various advantages. Backlight module, which provides a light source (i.e. backlight source) to the LCD, is an important part of the LCD. The backlight module is also one of the important factors to determine the display performance. Thus, increasing the light efficiency and illumination uniformity of the backlight module have great significance to the LCDs.

A light guide plate is a core component of the backlight module, which converts the optical path of the light emitted from the backlight source, and eventually uniformly outputs the light at a light emitting surface. Meanwhile, to improve the light efficiency of the backlight source, the light guide plate should be designed to minimize light loss. Thus, problems of further optimizing the structure of the light guide plate, improving the light efficiency of the backlight source, and enabling a more uniform illumination of the backlight module are highly desired to be solved in the field of display technology.

The disclosed light guide plate, backlight module and display device are directed to solve one or more problems in the art.

### BRIEF SUMMARY OF THE DISCLOSURE

One aspect of the present disclosure provides a light guide plate. The light guide plate comprises at least one light incident surface having at least one first light incident surface, a light emitting surface adjacent to the light incident surface, and a plurality of lateral faces adjacent to the light emitting surface. At least one lateral face adjacent to the light emitting surface is disposed with a plurality of reflective microstructures.

Another aspect of the present disclosure provides a backlight module. The backlight module comprises a light guide plate. The light guide plate comprises at least one light incident surface having at least one first light incident surface, a light emitting surface adjacent to the light incident surface, and a plurality of lateral faces adjacent to the light emitting surface. At least one lateral face adjacent to the light emitting surface is disposed with a plurality of reflective microstructures.

Another aspect of the present disclosure provides a backlight module a display device. The display device comprises a backlight module comprising a light guide plate. The light guide plate comprises at least one light incident surface having at least one first light incident surface, a light emitting surface adjacent to the light incident surface, and a plurality of lateral faces adjacent to the light emitting surface. At least one lateral face adjacent to the light emitting surface is disposed with a plurality of reflective microstructures.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a top view of an exemplary light guide plate consistent with disclosed embodiments;

FIG. 2 illustrates a top view of another exemplary light guide plate consistent with disclosed embodiments;

FIG. 3 illustrates a cross-sectional view of another exemplary light guide plate consistent with disclosed embodiments;

FIG. 4 illustrates an A-A′ sectional view of another exemplary light guide plate in FIG. 3 consistent with disclosed embodiments;

FIG. 5 illustrates a top view of another exemplary light guide plate consistent with disclosed embodiments;

FIG. 6 illustrates a top view of another exemplary light guide plate consistent with disclosed embodiments;

FIG. 7 illustrates a cross-sectional view of another exemplary light guide plate consistent with disclosed embodiments;

FIG. 8 illustrates a B-B′ sectional view of another exemplary light guide plate in FIG. 7 consistent with disclosed embodiments;

FIG. 9 illustrates a top view of another exemplary light guide plate consistent with disclosed embodiments;

FIG. 10 illustrates a top view of another exemplary light guide plate consistent with disclosed embodiments;

FIG. 11 illustrates a cross-sectional view of another exemplary light guide plate consistent with disclosed embodiments;

FIG. 12 illustrates a C-C′ sectional view of another exemplary light guide plate in FIG. 11 consistent with disclosed embodiments;

FIG. 13 illustrates a cross-sectional view of an exemplary backlight unit consistent with disclosed embodiments; and

FIG. 14 illustrates a schematic of an exemplary display device consistent with disclosed embodiments.

### DETAILED DESCRIPTION

Reference will now be made in detail to exemplary embodiments of the disclosure, which are illustrated in the accompanying drawings. Hereinafter, embodiments consistent with the disclosure will be described with reference to drawings. Wherever possible, the same reference numbers will be used throughout the drawings to refer to the same or like parts. It is apparent that the described embodiments are some but not all of the embodiments of the present disclosure. Based on the disclosed embodiments, persons of ordinary skill in the art may derive other embodiments consistent with the present disclosure, all of which are within the scope of the present disclosure.

It should be noted that, the disclosed embodiments are described in details with schematics. To better illustrate the present disclosure, dimensions and proportions of the components and structures may be adjusted, which may not be the true dimensions of the components and structures in a practical manufacturing.

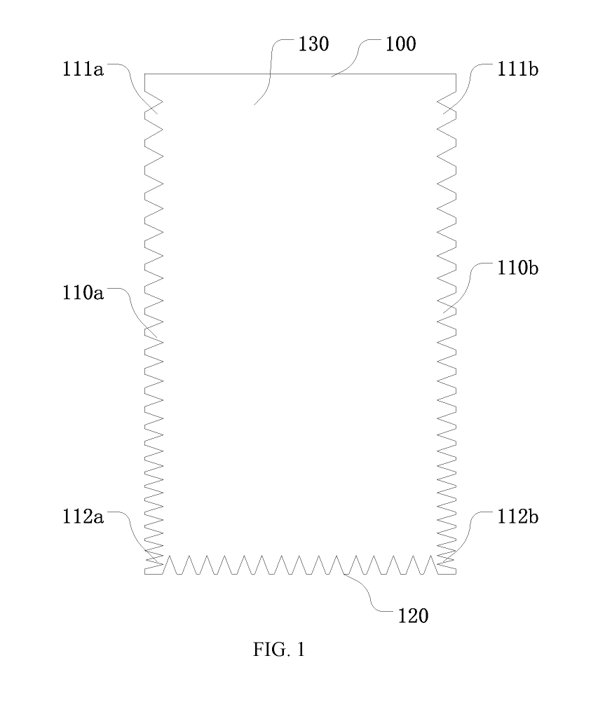

FIG. 1 illustrates a top view of an exemplary light guide plate consistent with disclosed embodiments. As shown in FIG. 1, the light guide plate may include a first light incident surface 100, a light emitting surface 130 adjacent to the first incident surface 100, and a plurality of lateral faces adjacent to the light emitting surface 130. The light emitting surface 130 may be a base of the light guide plate. At least one lateral face adjacent to the light emitting surface 130 may be disposed with a plurality of reflective microstructures.

A backlight source may output backlight to the first light incident surface 100. The backlight source may be disposed according to the first light incident surface 100. For example, the backlight source may include a plurality of light-emitting diodes (LEDs), an electroluminescent panel (ELP), a plurality cold cathode fluorescent lamps (CCFLs), a plurality of hot cathode fluorescent lamps (HCFLs), or a plurality of external electrode fluorescent lamps (EEFLs), etc. In particular, the LED backlight source may include a plurality of white LEDs or a plurality of RGB (red, green, blue) LEDs, etc.

The backlight entered from the first light incident surface 100 may propagate inside the light guide plate, and may be outputted at the light emitting surface 130 to illuminate display function materials, such as liquid crystals. Because liquid crystals may not be able to produce light by themselves (unlike for example LED, OLED), liquid crystals may need illumination to display visible images.

As described above, in the light guide plate, at least one lateral face adjacent to the light emitting surface may be disposed with the reflective microstructures. For example, the reflective microstructure may be an optical or electric microstructure (such as chrome) reflecting, splitting, scattering, or constraining the light, and the reflective microstructure may have a dimension in micrometer or sub-micrometer scale. The reflective microstructures may increase the number of the light reflection points at the lateral faces of the light guide plate and reduce the light loss at the lateral faces of the light guide plate. That is, more light may be reflected back inside the light guide plate while less light may exit from the lateral face. Thus, the light efficiency of the backlight source or the backlight efficiency may be improved.

On the other hand, the reflective microstructures may further scatter and reflect the light incident onto the reflective microstructure back into the light guide plate. Thus, the rays inside the light guide plate may have an increased distribution density and a more uniform distribution. Accordingly, the light outputted at the light emitting surface may be more uniform. For example, fewer hot spots, which may be caused by a non-uniform light distribution, may appear on the light emitting surface. The distribution density of rays inside the light guide plate may be referred as the number of rays per unit volume. Because of the light scattering on the reflective microstructures, the number of rays scattered and reflected back into the light guide plate may increase, and the distribution density of the rays inside the light guide plate may also increase.

In one embodiment, the plurality of lateral faces adjacent to the light emitting surface 130 may include a first lateral face 110a and a first lateral face 110b. Both the first lateral face 110a and the first lateral face 110b may be adjacent to the light emitting surface 130 and the first light incident surface 100. The reflective microstructures may be disposed on both the first lateral face 110a and the first lateral face 110b.

The first lateral face 110a may include a first position 111a and a second position 112a. The first position 111a may be at one end of the first lateral face 110a and adjacent to the first light incident surface 100. The second position 112a may be at the other end of the first lateral face 110a, i.e., away from the first light incident surface 100. That is, the first position 111a may be close to the backlight source, and the second position 112a may be far away from the backlight source.

Similarly, the first lateral face 110b may also include a first position 111b and a second position 112b. The first position 111b may be at one end of the first lateral face 110b and adjacent to the first light incident surface 100. The second position 112b may be at the other end of the first lateral face 110b, i.e., away from the first light incident surface 100. That is, the first position 111b may be close to the backlight source, and the second position 112b may be far away from the backlight source.

At the first lateral face 110a, the distribution density of the reflective microstructures at the first position 111a may be smaller than the distribution density of the reflective microstructures at the second position 112a. As the distance away from the first position 111a increases while the distance away from the second position 112a decreases, the distribution density of the reflective microstructures may gradually increase. That is, from the first position 111a to the second position 112a, the distribution density of the reflective microstructures may gradually increase.

Similarly, at the first lateral face 110b, the distribution density of the reflective microstructures at the first position 111b may be smaller than the distribution density of the reflective microstructures at the second position 112b. As the distance away from the first position 111b increases while the distance away from the second position 112b decreases, the distribution density of the reflective microstructure may gradually increase. That is, from the first position 111b to the second position 112b, the distribution density of the reflective microstructure may gradually increase.

For example, in a two-dimensional (2D) space, the distribution density of the reflective microstructures may be referred as the number of reflective microstructures per unit area. In a three-dimensional (3D) space, the distribution density of the reflective microstructures may be referred as the number of reflective microstructures per unit volume. A larger distribution density of the reflective microstructures may indicate more a larger number of reflective microstructures per unit area (volume), i.e., the reflective microstructures may be denser. A smaller distribution density of the reflective microstructures may indicate more a smaller number of reflective microstructures per unit area (volume), i.e., the reflective microstructures may be looser.

Further, from the first position 111a (111b) to the second position 112a (112b), the distribution density of the reflective microstructures may gradually increase according to various predetermined algorithms. That is, the distribution density of the reflective microstructures at a certain position in the first lateral face 111a (111b) may be calculated according to the predetermined algorithms. The predetermined algorithms may be designed according to different applications. For example, from the first position 111a (111b) to the second position 112a (112b), the distribution density of the reflective microstructures may linearly increase, nonlinearly increase, etc.

Further, the plurality of lateral faces may also include a second lateral face 120, which may be adjacent to the light emitting surface 130 and opposite to the first light incident surface 100. A plurality of reflective microstructures may also be disposed on the second lateral face 120. In particular, the reflective microstructures may be uniformly distributed on the second lateral face 120.

The reflective microstructure may be a wave-shaped groove microstructure. For example, as shown in FIG. 1, the wave-shaped groove microstructure may be a saw-tooth or zig-zag microstructure, which may include two planar facets arranged with an angular separation with respect to each other. The saw-tooth microstructure may be disposed towards the inside of the light guide plate. That is, the two planar facets may draw close to each other towards the inside of the light guide plate. In one embodiment, the two planar facets may have equal dimensions. In another embodiment, the two planar facets may have different dimensions.

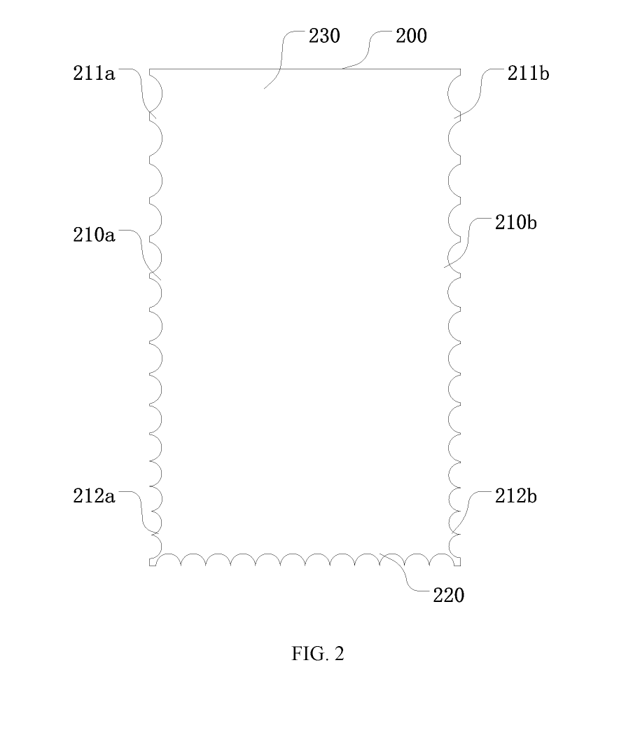

FIG. 2 illustrates a top view of another exemplary light guide plate consistent with disclosed embodiments. As shown in FIG. 2, the light guide plate may include a first light incident surface 200, a light emitting surface 230 adjacent to the first incident surface 200, and a plurality of lateral faces adjacent to the light emitting surface 230. The light emitting surface 230 may be a base of the light guide plate. At least one the lateral faces adjacent to the light emitting surface 230 may be disposed with a reflective microstructure.

A backlight source may output backlight to the first light incident surface 200. The backlight source may be disposed according to the first light incident surface 200. For example, the backlight source may include a plurality of light-emitting diodes (LEDs), an electroluminescent panel (ELP), a plurality cold cathode fluorescent lamps (CCFLs), a plurality of hot cathode fluorescent lamps (HCFLs), or a plurality of external electrode fluorescent lamps (EEFLs), etc. In particular, the LED backlight source may include a plurality of white LEDs or a plurality of RGB (red, green, blue) LEDs, etc.

The backlight entered from the first light incident surface 200 may propagate inside the light guide plate, and may be outputted at the light emitting surface 230 to illuminate display function materials, such as liquid crystals. Because liquid crystals may not be able to produce light by themselves (unlike for example LED, OLED), liquid crystals may need illumination to display visible images.

In one embodiment, the plurality of lateral faces may include a first lateral face 210a and a first lateral face 210b. Both the first lateral face 210a and the first lateral face 210b may be adjacent to the light emitting surface 230 and the first light incident surface 200. The reflective microstructures may be disposed on the first lateral face 210a and the first lateral face 210b.

The first lateral face 210a may include a first position 211a and a second position 212a. The first position 211a may be at one end of the first lateral face 210a and adjacent to the first light incident surface 200. The second position 212a may be at the other end of the first lateral face 210a, i.e., away from the first light incident surface 200. That is, the first position 211a may be close to the backlight source, and the second position 212a may be far away from the backlight source.

Similarly, the first lateral face 210b may also include a first position 211b and a second position 212b. The first position 211b may be at one end of the first lateral face 210b and adjacent to the first light incident surface 200. The second position 212b may be at the other end of the first lateral face 210b, i.e., away from the first light incident surface 200. That is, the first position 211b may be close to the backlight source, and the second position 212b may be far away from the backlight source.

At the first lateral face 210a, the distribution density of the reflective microstructures at the first position 211a may be smaller than the distribution density of the reflective microstructures at the second position 212a. As the distance away from the first position 211a increases while the distance away from the second position 212a decreases, the distribution density of the reflective microstructures may gradually increase. That is, from the first position 211a to the second position 212a, the distribution density of the reflective microstructures may gradually increase.

Similarly, at the first lateral face 210b, the distribution density of the reflective microstructures at the first position 211b may be smaller than the distribution density of the reflective microstructures at the second position 212b. As the distance away from the first position 211b increases while the distance away from the second position 212b decreases, the distribution density of the reflective microstructures may gradually increase. That is, from the first position 211b to the second position 212b, the distribution density of the reflective microstructures may gradually increase.

For example, from the first position 211a (211b) to the second position 212a (212b), the distribution density of the reflective microstructures may gradually increase according to various predetermined algorithms. That is, the distribution density of the reflective microstructures at a certain position in the first lateral face 211a (211b) may be calculated according to the predetermined algorithms. The predetermined algorithms may be designed according to different applications. For example, from the first position 211a (211b) to the second position 212a (212b), the distribution density of the reflective microstructures may linearly increase, nonlinearly increase, etc.

Further, the plurality of lateral faces may also include a second lateral face 220, which may be adjacent to the light emitting surface 230 and opposite to the first light incident surface 200. A plurality of reflective microstructures may also be disposed on the second lateral face 220. The reflective microstructure may be uniformly distributed within the second lateral face 220.

The reflective microstructure may be a wave-shaped groove microstructure. For example, as shown in FIG. 2, the wave-shaped groove microstructure may be a concave arc-shaped microstructure disposed towards the inside of the light guide plate. That is, the vertex of the concave may be disposed towards the inside of the light guide plate.

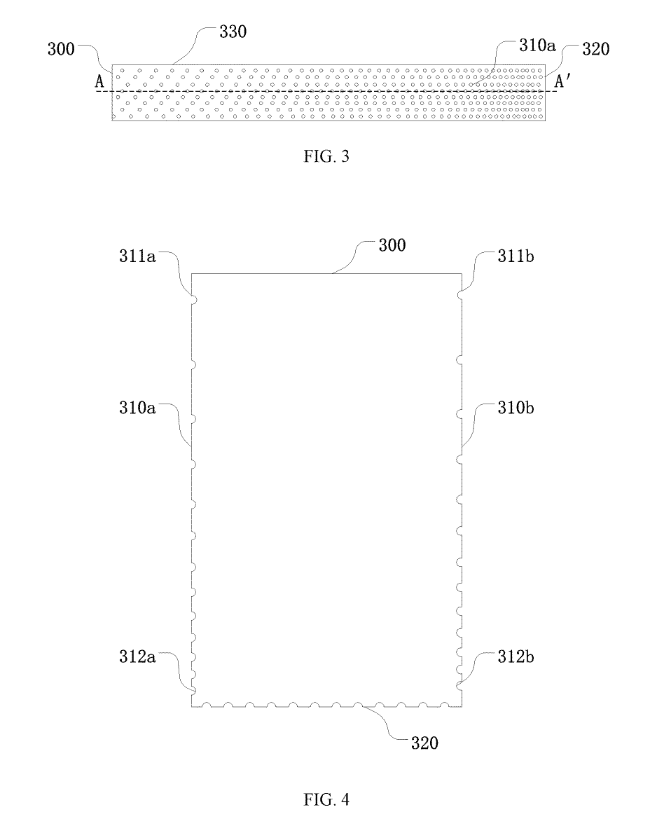

FIG. 3 illustrates a cross-sectional view of another exemplary light guide plate consistent with disclosed embodiments. FIG. 4 illustrates an A-A′ sectional view of another exemplary light guide plate in FIG. 3 consistent with disclosed embodiments.

As shown in FIG. 3 and FIG. 4, the light guide plate may include a first light incident surface 300, a light emitting surface 330 adjacent to the first incident surface 300, and a plurality of lateral faces adjacent to the light emitting surface 330. The light emitting surface 330 may be a base of the light guide plate. At least of the lateral faces adjacent to the light emitting surface 330 may be disposed with a plurality of reflective microstructures.

A backlight source may output backlight to the first light incident surface 300. The backlight source may be disposed according to the first light incident surface 300. For example, the backlight source may include a plurality of light-emitting diodes (LEDs), an electroluminescent panel (ELP), a plurality cold cathode fluorescent lamps (CCFLs), a plurality of hot cathode fluorescent lamps (HCFLs), or a plurality of external electrode fluorescent lamps (EEFLs), etc. In particular, the LED backlight source may include a plurality of white LEDs or a plurality of RGB (red, green, blue) LEDs, etc.

The backlight entered from the first light incident surface 300 may propagate inside the light guide plate, and may be outputted at the light emitting surface 330 to illuminate display function materials, such as liquid crystals. Because liquid crystals may not be able to produce light by themselves (unlike for example LED, OLED), liquid crystals may need illumination to display visible images.

In one embodiment, the plurality of lateral faces may include a first lateral face 310a and a first lateral face 310b. Both the first lateral face 310a and the first lateral face 310b may be adjacent to the light emitting surface 330 and the first light incident surface 300. The reflective microstructures may be disposed on the first lateral face 310a and the first lateral face 310b.

The first lateral face 310a may include a first position 311a and a second position 313a. As shown in FIG. 4, the first position 311a may be at one end of the first lateral face 310a and adjacent to the first light incident surface 300. The second position 312a may be at the other end of the first lateral face 310a, i.e., away from the first light incident surface 300. That is, the first position 311a may be close to the backlight source, and the second position 312a may be far away from the backlight source.

Similarly, the first lateral face 310b may also include a first position 311b and a second position 312b. The first position 311b may be at one end of the first lateral face 310b and adjacent to the first light incident surface 300. The second position 312b may be at the other end of the first lateral face 310b, i.e., away from the first light incident surface 300. That is, the first position 311b may be close to the backlight source, and the second position 312b may be far away from the backlight source.

At the first lateral face 310a, the distribution density of the reflective microstructures at the first position 311a may be smaller than the distribution density of the reflective microstructures at the second position 312a. As the distance away from the first position 311a increases while the distance away from the second position 312a decreases, the distribution density of the reflective microstructures may gradually increase. That is, from the first position 311a to the second position 312a, the distribution density of the reflective microstructures may gradually increase.

Similarly, within the first lateral face 310b, the distribution density of the reflective microstructure at the first position 311b may be smaller than the distribution density of the reflective microstructure at the second position 312b. As the distance away from the first position 311b increases while the distance away from the second position 312b decreases, the distribution density of the reflective microstructures may gradually increase. That is, from the first position 311b to the second position 312b, the distribution density of the reflective microstructure may gradually increase.

For example, from the first position 311a (311b) to the second position 312a (312b), the distribution density of the reflective microstructures may gradually increase according to various predetermined algorithms. That is, the distribution density of the reflective microstructures at a certain position in the first lateral face 311a (311b) may be calculated according to the predetermined algorithms. The predetermined algorithms may be designed according to different applications. For example, from the first position 311a (311b) to the second position 312a (312b), the distribution density of the reflective microstructures may linearly increase, nonlinearly increase, etc.

Further, the plurality of lateral faces may also include a second lateral face 320, which may be adjacent to the light emitting surface 330 and opposite to the first light incident surface 300. The second lateral face 320 may also be disposed with a plurality of reflective microstructures. In particular, the reflective microstructures may be uniformly distributed within the second lateral face 330.

The reflective microstructure may be a dot microstructure. For example, as shown in FIG. 4, the dot microstructure may have a concave shape and the vertex of the concave may be disposed towards the inside of the light guide plate.

Thus, in the disclosed embodiments, through disposing the reflective microstructures at the first lateral faces adjacent to the first light incident surface, such as the saw-tooth microstructures, arc-shaped microstructures, and dot microstructures, the number of the light reflection points at the first lateral faces may be increased, thus the backlight efficiency and backlight illumination uniformity may be improved.

On the other hand, the distribution density of the reflective microstructures (i.e., reflective microstructure distribution density) at the first lateral face may gradually increase with the distance away from the first light incident surface. A larger reflective microstructure distribution density may indicate more light refection points, i.e., more light may be further scattered and reflected back inside the light guide plate. A smaller reflective microstructure distribution density may indicate fewer light refection points, i.e., less light may be further scattered and reflected back inside the light guide plate. Thus, from the end of the first lateral face close to the backlight source (i.e., the first position) to the other end of the first lateral face far away from the backlight source (i.e., the second position), the light distribution may become more uniform. Accordingly, the light outputted at the light emitting surface may be more uniform.

In addition, the reflective microstructures may also be disposed on second lateral face, and the number of the light reflection points within the second lateral face may also be increased. Thus, the light efficiency may be further improved.

Further, the reflective microstructures may be continuous disposed on the first lateral face and the second lateral face, respectively. In certain embodiments, each reflective microstructure may have a same dimension. For example, from the first position to the second position, the dimension of each reflective microstructure may keep the same, while the gap between two adjacent reflective microstructures or the period of the reflective microstructures may decrease. Thus, from the first position to the second position, the distribution density of the reflective microstructures may gradually increase.

In certain other embodiments, each reflective microstructure may have a different dimension. For example, from the first position to the second position, the dimension of each reflective microstructure may change and, meanwhile, the gap between two adjacent reflective microstructures or the period of the reflective microstructures may decrease. For example, from the first position to the second position, the angular separation between the two planar facets of the saw-tooth or zig-zag microstructure may gradually decrease, the aperture of the concave arc-shaped microstructure may gradually decrease, the aperture of the dot microstructure may gradually decrease, etc.

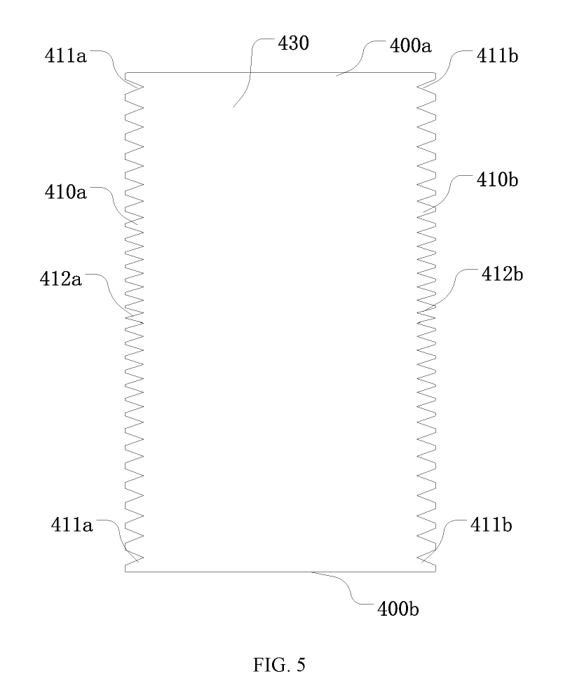

FIG. 5 illustrates a top view of another exemplary light guide plate consistent with disclosed embodiments. As shown in FIG. 5, the light guide plate may include a first light incident surface 400a, a light emitting surface 430 adjacent to the first incident surface 400a, and a plurality of lateral faces adjacent to the light emitting surface 430. The light emitting surface 430 may be a base of the light guide plate. At least one lateral face adjacent to the light emitting surface 430 may be disposed with a plurality of reflective microstructures.

A backlight source may output backlight to the first light incident surface 400. The backlight source may be disposed according to the first light incident surface 400. For example, the backlight source may include a plurality of light-emitting diodes (LEDs), an electroluminescent panel (ELP), a plurality cold cathode fluorescent lamps (CCFLs), a plurality of hot cathode fluorescent lamps (HCFLs), or a plurality of external electrode fluorescent lamps (EEFLs), etc. In particular, the LED backlight source may include a plurality of white LEDs or a plurality of RGB (red, green, blue) LEDs, etc.

The backlight entered from the first light incident surface 400 may propagate inside the light guide plate, and may be outputted at the light emitting surface 430 to illuminate display function materials, such as liquid crystals. Because liquid crystals may not be able to produce light by themselves (unlike for example LED, OLED), liquid crystals may need illumination to display visible images.

As described above, at least one lateral face of the light guide plate adjacent to the light emitting surface may be disposed with the reflective microstructure. For example, the reflective microstructure may be an optical or electric microstructure (such as chrome) reflecting, splitting, scattering, or constraining the light, and the reflective microstructure may have a dimension in micrometer or sub-micrometer scale. The reflective microstructures may increase the number of the light reflection points at the lateral faces of the light guide plate and reduce the light loss at the lateral faces of the light guide plate. That is, more light may be reflected back inside the light guide plate while less light may exit from the lateral face. Thus, the light efficiency of the backlight source or the backlight efficiency may be improved.

On the other hand, the reflective microstructures may further scatter and reflect the light incident onto the reflective microstructure back into the light guide plate. Thus, the rays inside the light guide plate may have an increased distribution density and a more uniform distribution. Accordingly, the light outputted at the light emitting surface may also be more uniform. For example, fewer hot spots, which may be caused by a non-uniform light distribution, may appear on the light emitting surface. The distribution density of rays inside the light guide plate may be referred as the number of rays per unit volume. Because of the light scattering on the reflective microstructures, the number of rays scattered and reflected back into the light guide plate may increase, and the distribution density of the rays inside the light guide plate may also increase.

In one embodiment, the plurality of lateral faces may include a first lateral face 410a and a first lateral face 410b. Both the first lateral face 410a and the first lateral face 410b may be adjacent to the light emitting surface 430 and adjacent to the first light incident surface 400a. The reflective microstructures may be disposed on the first lateral face 410a and the first lateral face 410b.

Further, the light guide plate may also include a second light incident surface 400b, which may be opposite to the first light incident surface 400a and adjacent to the first lateral face 410a and the first lateral face 410b. A backlight source may output light to the second light incident surface 400b. The backlight source may be similar to the backlight source outputting light to the first light incident surface 400a, which may not be repeated here.

The first lateral face 410a may have a plurality of first positions 411a and a second positions 412a. For example, as shown in FIG. 5, the first lateral face 410a may have two first positions 411a. One first position 411a may be at one end of the first lateral face 410a and adjacent to the first light incident surface 400a, and the other first position 411a may be at the other end of the first lateral face 410a and adjacent to the second light incident surface 400b. The second position 412a may have an equal distance to the first light incident surface 400a and the second light incident surface 400b, i.e., the second position 412a may be at the middle of the first lateral face 410a. That is, the first position 411a may be close to the backlight source, while the second position 412a may be far away from the backlight source.

Similarly, the first lateral face 410b may have a plurality of first positions 411b and a second position 412b. For example, as shown in FIG. 5, the first lateral face 410b may have two first positions 411b. One first position 411b may be at one end of the first lateral face 410b and adjacent to the first light incident surface 400a, and the other first position 411b may be at the other end of the first lateral face 410b and adjacent to the second light incident surface 400b. The second position 412b may have an equal distance to the first light incident surface 400a and the second light incident surface 400b, i.e., the second position 412b may be at the middle of the first lateral face 410b. That is, the first position 411b may be close to the backlight source, while the second position 412b may be far away from the backlight source.

At the first lateral face 410a, the distribution density of the reflective microstructures at either first position 411a may be smaller than the distribution density of the reflective microstructures at the second position 412a. As the distance away from the first position 411a increases while the distance away from the second position 412a decreases, the distribution density of the reflective microstructure may gradually increase. That is, from the first position 411a to the second position 412a, the distribution density of the reflective microstructures may gradually increase.

Similarly, at the first lateral face 410b, the distribution density of the reflective microstructure at either first position 411b may be smaller than the distribution density of the reflective microstructure at the second position 412b. As the distance away from the first position 411b increases while the distance away from the second position 412b decreases, the distribution density of the reflective microstructure may gradually increase. That is, from the first position 411b to the second position 412b, the distribution density of the reflective microstructure may gradually increase.

For example, from the first position 411a (411b) to the second position 412a (412b), the distribution density of the reflective microstructures may gradually increase according to various predetermined algorithms. That is, the distribution density of the reflective microstructures at a certain position in the first lateral face 411a (411b) may be calculated according to the predetermined algorithms. The predetermined algorithms may be designed according to different applications. For example, from the first position 411a (411b) to the second position 412a (412b), the distribution density of the reflective microstructures may linearly increase, nonlinearly increase, etc.

The reflective microstructure may be a wave-shaped groove microstructure. For example, as shown in FIG. 5, the wave-shaped groove microstructure may be a saw-tooth or zig-zag microstructure, which may include two planar facets arranged with an angular separation with respect to each other. The saw-tooth microstructure may be disposed towards the inside of the light guide plate. That is, the two planar facets may draw close to each other towards the inside of the light guide plate. In one embodiment, the two planar facets may have equal dimensions. In another embodiment, the two planar facets may have different dimensions.

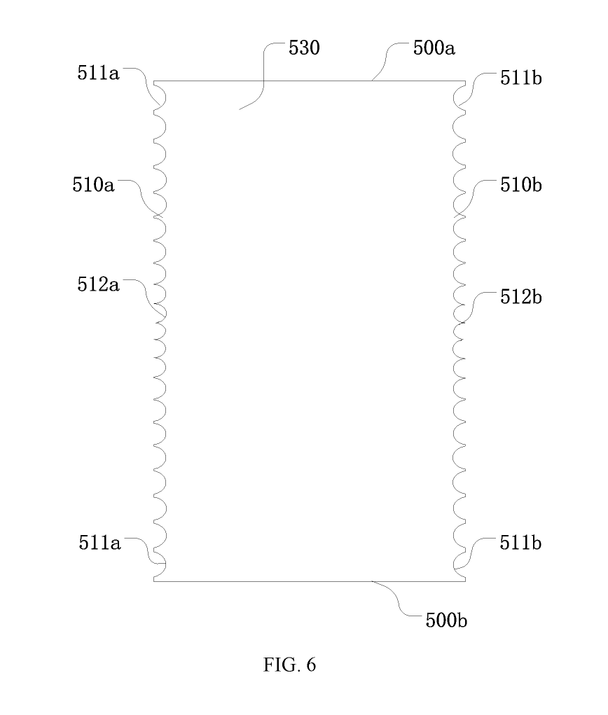

FIG. 6 illustrates a top view of another exemplary light guide plate consistent with disclosed embodiments. As shown in FIG. 6, the light guide plate may include a first light incident surface 500a, a light emitting surface 530 adjacent to the first incident surface 500a, and a plurality of lateral faces adjacent to the light emitting surface 530. The light emitting surface 530 may be a base of the light guide plate. At least one lateral face adjacent to the light emitting surface 530 may be disposed with a plurality of reflective microstructures.

A backlight source may output backlight to the first light incident surface 500.

The backlight source may be disposed according to the first light incident surface 500. For example, the backlight source may include a plurality of light-emitting diodes (LEDs), an electroluminescent panel (ELP), a plurality cold cathode fluorescent lamps (CCFLs), a plurality of hot cathode fluorescent lamps (HCFLs), or a plurality of external electrode fluorescent lamps (EEFLs), etc. In particular, the LED backlight source may include a plurality of white LEDs or a plurality of RGB (red, green, blue) LEDs, etc.

The backlight entered from the first light incident surface 500 may propagate inside the light guide plate, and may be outputted at the light emitting surface 530 to illuminate display function materials, such as liquid crystals. Because liquid crystals may not be able to produce light by themselves (unlike for example LED, OLED), liquid crystals may need illumination to display visible images.

In one embodiment, the plurality of lateral faces may include a first lateral face 510a and a first lateral face 510b. Both the first lateral face 510a and the first lateral face 510b may be adjacent to the light emitting surface 530 and adjacent to the first light incident surface 500. The reflective microstructures may be disposed on the first lateral face 510a and the first lateral face 510b.

Further, the light guide plate may also include a second light incident surface 500b, which may be opposite to the first light incident surface 500a and adjacent to the first lateral face 510a and the first lateral face 510b. A backlight source may output light to the second light incident surface 500b. The backlight source may be similar to the backlight source outputting light to the first light incident surface 500a, which may not be repeated here.

The first lateral face 510a may have a plurality of first positions 511a and a second positions 512a. For example, as shown in FIG. 6, the first lateral face 510a may have two first positions 511a. One first position 511a may be at one end of the first lateral face 510a and adjacent to the first light incident surface 500a, and the other first position 511a may be at the other end of the first lateral face 510a and adjacent to the second light incident surface 500b. The second position 512a may have an equal distance to the first light incident surface 500a and the second light incident surface 500b, i.e., the second position 512a may be at the middle of the first lateral face 510a. That is, the first position 511a may be close to the backlight source, while the second position 512a may be far away from the backlight source.

Similarly, the first lateral face 510b may have a plurality of first positions 511b and a second position 512b. For example, as shown in FIG. 6, the first lateral face 510b may have two first positions 511b. One first position 511b may be at one end of the first lateral face 510b and adjacent to the first light incident surface 500a, and the other first position 511b may be at the other end of the first lateral face 510b and adjacent to the second light incident surface 500b. The second position 512b may have an equal distance to the first light incident surface 500a and the second light incident surface 500b, i.e., the second position 512b may be at the middle of the first lateral face 510b. That is, the first position 511b may be close to the backlight source, while the second position 512b may be far away from the backlight source.

At the first lateral face 510a, the distribution density of the reflective microstructures at either first position 511a may be smaller than the distribution density of the reflective microstructures at the second position 512a. As the distance away from the first position 511a increases while the distance away from the second position 512a decreases, the distribution density of the reflective microstructures may gradually increase. That is, from the first position 511a to the second position 512a, the distribution density of the reflective microstructures may gradually increase.

Similarly, at the first lateral face 510b, the distribution density of the reflective microstructure at either first position 511b may be smaller than the distribution density of the reflective microstructure at the second position 512b. As the distance away from the first position 511b increases while the distance away from the second position 512b decreases, the distribution density of the reflective microstructures may gradually increase. That is, from the first position 511b to the second position 512b, the distribution density of the reflective microstructures may gradually increase.

For example, from the first position 511a (511b) to the second position 512a (512b), the distribution density of the reflective microstructures may gradually increase according to various predetermined algorithms. That is, the distribution density of the reflective microstructures at a certain position in the first lateral face 511a (511b) may be calculated according to the predetermined algorithms. The predetermined algorithms may be designed according to different applications. For example, from the first position 511a (511b) to the second position 512a (512b), the distribution density of the reflective microstructures may linearly increase, nonlinearly increase, etc.

The reflective microstructure may be a wave-shaped groove microstructure. For example, as shown in FIG. 6, the wave-shaped groove microstructure may be a concave arc-shaped microstructure disposed towards the inside of the light guide plate. That is, the vertex of the concave may be disposed towards the inside of the light guide plate.

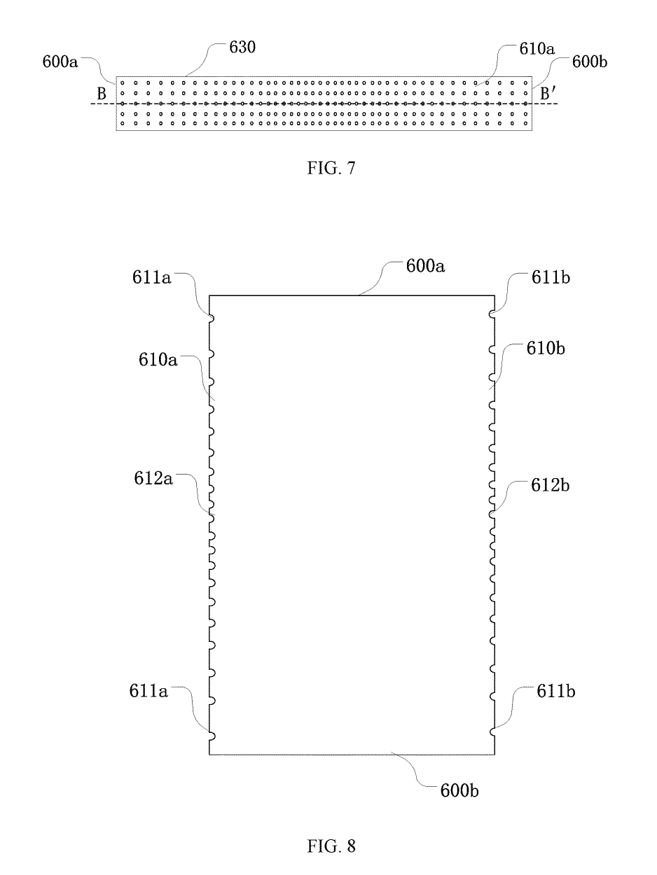

FIG. 7 illustrates a cross-sectional view of another exemplary light guide plate consistent with disclosed embodiments. FIG. 8 illustrates a B-B′ sectional view of another exemplary light guide plate in FIG. 7 consistent with disclosed embodiments.

As shown in FIG. 7 and FIG. 8, the light guide plate may include a first light incident surface 600a, a light emitting surface 630 adjacent to the first incident surface 600a, and a plurality of lateral faces adjacent to the light emitting surface 630. The light emitting surface 630 may be a base of the light guide plate. At least one lateral face adjacent to the light emitting surface 630 may be disposed with a plurality of reflective microstructures.

A backlight source may output backlight to the first light incident surface 600. The backlight source may be disposed according to the first light incident surface 600. For example, the backlight source may include a plurality of light-emitting diodes (LEDs), an electroluminescent panel (ELP), a plurality cold cathode fluorescent lamps (CCFLs), a plurality of hot cathode fluorescent lamps (HCFLs), or a plurality of external electrode fluorescent lamps (EEFLs), etc. In particular, the LED backlight source may include a plurality of white LEDs or a plurality of RGB (red, green, blue) LEDs, etc.

The backlight entered from the first light incident surface 600 may propagate inside the light guide plate, and may be outputted at the light emitting surface 630 to illuminate display function materials, such as liquid crystals. Because liquid crystals may not be able to produce light by themselves (unlike for example LED, OLED), liquid crystals may need illumination to display visible images.

In one embodiment, the plurality of lateral faces may include a first lateral face 610a and a first lateral face 610b. Both the first lateral face 610a and the first lateral face 610b may be adjacent to the light emitting surface 630 and adjacent to the first light incident surface 600. The reflective microstructures may be disposed on the first lateral face 610a and the first lateral face 610b.

Further, the light guide plate may also include a second light incident surface 600b, which may be opposite to the first light incident surface 600a and adjacent to the first lateral face 610a and the first lateral face 610b. A backlight source may output light to the second light incident surface 600b. The backlight source may be similar to the backlight source outputting light to the first light incident surface 600a, which may not be repeated here.

The first lateral face 610a may have a plurality of first positions 611a and a second positions 612a. For example, as shown in FIG. 8, the first lateral face 610a may have two first positions 611a. One first position 611a may be at one end of the first lateral face 610a and adjacent to the first light incident surface 600a, and the other first position 611a may be at the other end of the first lateral face 610a and adjacent to the second light incident surface 600b. The second position 612a may have an equal distance to the first light incident surface 600a and the second light incident surface 600b, i.e., the second position 612a may be at the middle of the first lateral face 610a. That is, the first position 611a may be close to the backlight source, while the second position 612a may be far away from the backlight source.

Similarly, the first lateral face 610b may have a plurality of first positions 611b and a second positions 612b. For example, as shown in FIG. 8, the first lateral face 610b may have two first positions 611b. One first position 611b may be at one end of the first lateral face 610b and adjacent to the first light incident surface 600a, and the other first position 611b may be at the other end of the first lateral face 610b and adjacent to the second light incident surface 600b. The second position 612b may have an equal distance to the first light incident surface 600a and the second light incident surface 600b, i.e., the second position 612b may be at the middle of the first lateral face 610b. That is, the first position 611b may be close to the backlight source, while the second position 612b may be far away from the backlight source.

At the first lateral face 610a, the distribution density of the reflective microstructure at either first position 611a may be smaller than the distribution density of the reflective microstructure at the second position 612a. As the distance away from the first position 611a increases while the distance away from the second position 612a decreases, the distribution density of the reflective microstructures may gradually increase. That is, from the first position 611a to the second position 612a, the distribution density of the reflective microstructure may gradually increase.

Similarly, within the first lateral face 610b, the distribution density of the reflective microstructure at either first position 611b may be smaller than the distribution density of the reflective microstructure at the second position 612b. As the distance away from the first position 611b increases while the distance away from the second position 612b decreases, the distribution density of the reflective microstructures may gradually increase. That is, from the first position 611b to the second position 612b, the distribution density of the reflective microstructure may gradually increase.

For example, from the first position 611a (611b) to the second position 612a (612b), the distribution density of the reflective microstructures may gradually increase according to various predetermined algorithms. That is, the distribution density of the reflective microstructures at a certain position in the first lateral face 611a (611b) may be calculated according to the predetermined algorithms. The predetermined algorithms may be designed according to different applications. For example, from the first position 611a (611b) to the second position 612a (612b), the distribution density of the reflective microstructures may linearly increase, nonlinearly increase, etc.

The reflective microstructure may be a dot microstructure. For example, as shown in FIG. 8, the dot microstructure may have a concave shape and the vertex of the concave may be disposed towards the inside of the light guide plate.

In the disclosed embodiments, through disposing the reflective microstructures at the first lateral faces adjacent to both the first light incident surface and the second light incident surface, such as the saw-tooth microstructures, arc-shaped microstructures, and dot microstructures, the number of the light reflection points at the first lateral faces may be increased, thus the backlight efficiency and backlight illumination uniformity may be improved.

On the other hand, at the first lateral face, the distribution density of the reflective microstructures (i.e., reflective microstructure distribution density) may gradually increase with the distance away from the first (second) light incident surface. That is, the reflective microstructure distribution density may gradually increase from the first position (i.e., the end of the first lateral face) to the second position (i.e., the middle of the first lateral face).

A larger reflective microstructure distribution density may indicate more light refection points, i.e., more light may be further scattered and reflected back inside the light guide plate. A smaller reflective microstructure distribution density may indicate fewer light refection points, i.e., less light may be further scattered and reflected back inside the light guide plate. Thus, from the end of the first lateral face close to the backlight source (i.e., the first position) to the middle of the first lateral face far away from the backlight source (i.e., the second position), the light distribution may become more uniform. Accordingly, the light outputted at the light emitting surface may also be more uniform.

Further, the reflective microstructures may be continuous disposed on the first lateral faces. In certain embodiments, each reflective microstructure may have a same dimension. For example, from the first position to the second position, the dimension of each reflective microstructure may keep the same, while the gap between two adjacent reflective microstructures or the period of the reflective microstructures may decrease. Thus, from the first position to the second position, the distribution density of the reflective microstructures may gradually increase.

In certain other embodiments, each reflective microstructure may have a different dimension. For example, from the first position to the second position, the dimension of each reflective microstructure may change and, meanwhile, the gap between two adjacent reflective microstructures or the period of the reflective microstructures may decrease. For example, from the first position to the second position, the angular separation between the two planar facets of the saw-tooth or zig-zag microstructure may gradually decrease, the aperture of the concave arc-shaped microstructure may gradually decrease, the aperture of the dot microstructure may gradually decrease, etc.

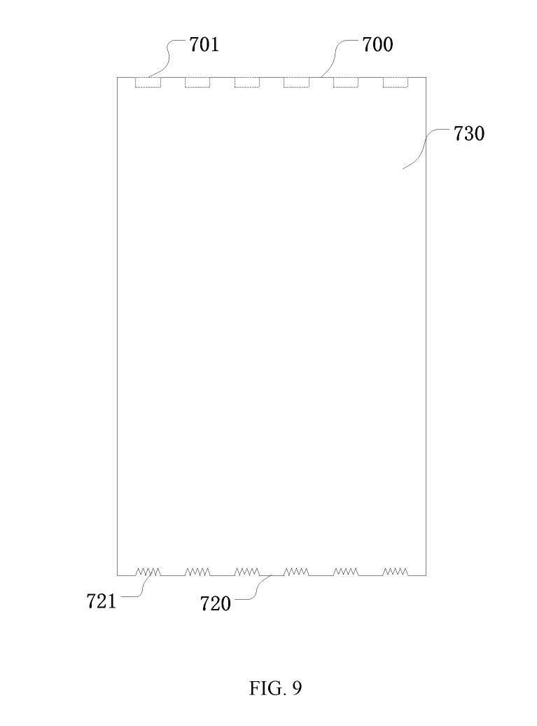

FIG. 9 illustrates a top view of another exemplary light guide plate consistent with disclosed embodiments. As shown in FIG. 9, the light guide plate may include a first light incident surface 700a, a light emitting surface 730 adjacent to the first incident surface 700, and a plurality of lateral faces adjacent to the light emitting surface 730. The light emitting surface 730 may be a base of the light guide plate. At least one lateral face adjacent to the light emitting surface 730 may be disposed with a plurality of reflective microstructures.

A backlight source may output backlight to the first light incident surface 700. The backlight source may be disposed according to the first light incident surface 700. For example, the backlight source may include a plurality of light-emitting diodes (LEDs), an electroluminescent panel (ELP), a plurality cold cathode fluorescent lamps (CCFLs), a plurality of hot cathode fluorescent lamps (HCFLs), or a plurality of external electrode fluorescent lamps (EEFLs), etc. In particular, the LED backlight source may include a plurality of white LEDs or a plurality of RGB (red, green, blue) LEDs, etc.

The backlight entered from the first light incident surface 400 may propagate inside the light guide plate, and may be outputted at the light emitting surface 430 to illuminate display function materials, such as liquid crystals. Because liquid crystals may not be able to produce light by themselves (unlike for example LED, OLED), liquid crystals may need illumination to display visible images.

As described above, at least one lateral face of the light guide plate adjacent to the light emitting surface may be disposed with the reflective microstructure. For example, the reflective microstructure may be an optical or electric microstructure (such as chrome) reflecting, splitting, scattering, or constraining the light, and the reflective microstructure may have a dimension in micrometer or sub-micrometer scale. The reflective microstructures may increase the number of the light reflection points at the lateral face of the light guide plate and reduce the light loss at the lateral face of the light guide plate. That is, more light may be reflected back inside the light guide plate while less light may exit from the lateral face. Thus, the light efficiency of the backlight source or the backlight efficiency may be improved.

On the other hand, the reflective microstructures may further scatter and reflect the light incident onto the reflective microstructures back into the light guide plate. Thus, the rays inside the light guide plate may have an increased distribution density and a more uniform distribution. Accordingly, the light outputted at the light emitting surface may also be more uniform. For example, fewer hot spots, which may be caused by a non-uniform light distribution, may appear on the light emitting surface. The distribution density of rays inside the light guide plate may be referred as the number of rays per unit volume. Because of the light scattering on the reflective microstructures, the number of rays scattered and reflected back into the light guide plate may increase, and the distribution density of the rays inside the light guide plate may also increase.

In one embodiment, the lateral face of the light guide plate adjacent to the light emitting surface may have a second lateral face 720, which may be adjacent to the light emitting surface 730 and opposite to the first light incident surface 700. The second lateral face 720 may be disposed with the reflective microstructures. In particular, the second lateral face 720 may only have certain regions disposed with the reflective microstructures. That is, the reflective microstructures may not be continuous disposed on the second lateral face 720.

The first incident surface 700 may include a plurality of third positions 701 (denoted by the dashed lines in FIG. 9), which may exactly face the diodes or lamps in the backlight source. The second lateral face 720 may include a plurality of fourth positions 721, which may correspond to the third positions at the first incident surface 700. For example, the fourth positions at the second lateral face 720 may one-to-one correspond to the third positions at the first incident surface 700. That is, the fourth positions at the second lateral face 720 may exactly face the diodes or lamps in the backlight source. The reflective microstructures may be disposed on the fourth positions 721. It should be noted that, in FIG. 9, the third positions 701 are denoted by the dashed lines for illustrative purposes, which may not be practical structures.

The reflective microstructure may be a wave-shaped groove microstructure. For example, as shown in FIG. 9, the wave-shaped groove microstructure may be a saw-tooth microstructure, which may include two planar facets arranged with an angular separation with respect to each other. The saw-tooth microstructure may be disposed towards the inside of the light guide plate. That is, the two planar facets may draw close to each other towards the inside of the light guide plate. In one embodiment, the two planar facets may have equal dimensions. In another embodiment, the two planar facets may have different dimensions.

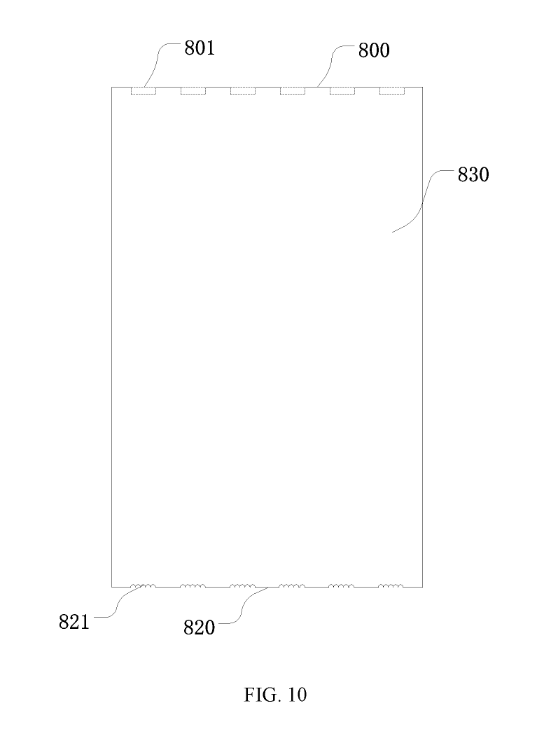

FIG. 10 illustrates a top view of another exemplary light guide plate consistent with disclosed embodiments. As shown in FIG. 10, the light guide plate may include a first light incident surface 800a, a light emitting surface 830 adjacent to the first incident surface 800, and a plurality of lateral faces adjacent to the light emitting surface 830. The light emitting surface 830 may be a base of the light guide plate. At least one lateral face adjacent to the light emitting surface 830 may be disposed with a plurality of reflective microstructures.

A backlight source may output backlight to the first light incident surface 800. The backlight source may be disposed according to the first light incident surface 800. For example, the backlight source may include a plurality of light-emitting diodes (LEDs), an electroluminescent panel (ELP), a plurality cold cathode fluorescent lamps (CCFLs), a plurality of hot cathode fluorescent lamps (HCFLs), or a plurality of external electrode fluorescent lamps (EEFLs), etc. In particular, the LED backlight source may include a plurality of white LEDs or a plurality of RGB (red, green, blue) LEDs, etc.

The backlight entered from the first light incident surface 800 may propagate inside the light guide plate, and may be outputted at the light emitting surface 830 to illuminate display function materials, such as liquid crystals. Because liquid crystals may not be able to produce light by themselves (unlike for example LED, OLED), liquid crystals may need illumination to display visible images.

In one embodiment, the lateral faces may include a second lateral face 820, which may be adjacent to the light emitting surface 830 and opposite to the first light incident surface 800. The reflective microstructures may be disposed on the second lateral face 820. In particular, the second lateral face 820 may only have certain regions disposed with the reflective microstructures. That is, the reflective microstructures may not be continuous disposed on the second lateral face 820.

Further, the first incident surface 800 may include a plurality of third positions 801 (denoted by the dashed lines in FIG. 10), which may exactly face the diodes or lamps in the backlight source. The second lateral face 820 may include a plurality of fourth positions 821, which may correspond to the third positions within the first incident surface 800. For example, the fourth positions at the second lateral face 820 may one-to-one correspond to the third positions at the first incident surface 800. That is, the fourth positions at the second lateral face 820 may exactly face the diodes or lamps in the backlight source. The reflective microstructures may be disposed on the fourth positions 821. It should be noted that, in FIG. 10, the third positions 801 are denoted by the dashed lines for illustrative purposes, which may not be practical structures.

The reflective microstructure may be a wave-shaped groove. For example, as shown in FIG. 10, the wave-shaped groove may be a concave arc-shaped groove, and the vertex of the concave may be disposed towards the inside of the light guide plate.

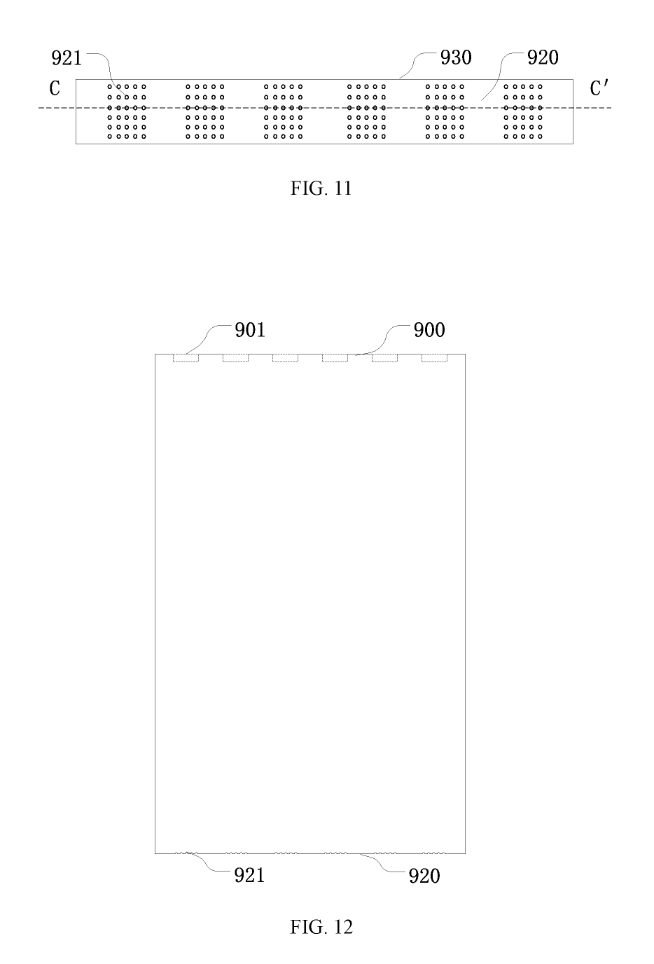

FIG. 11 illustrates a cross-sectional view of another exemplary light guide plate consistent with disclosed embodiments. FIG. 12 illustrates a C-C′ sectional view of another exemplary light guide plate in FIG. 11 consistent with disclosed embodiments.

As shown in FIG. 11 and FIG. 12, the light guide plate may include a first light incident surface 900a, a light emitting surface 930 adjacent to the first incident surface 900, and a plurality of lateral faces adjacent to the light emitting surface 930 disposed with a plurality of reflective microstructures. The light emitting surface 930 may be a base of the light guide plate. At least one lateral face adjacent to the light emitting surface 930 may be disposed with a plurality of reflective microstructures.

A backlight source may output backlight to the first light incident surface 900. The backlight source may be disposed according to the first light incident surface 900. For example, the backlight source may include a plurality of light-emitting diodes (LEDs), an electroluminescent panel (ELP), a plurality cold cathode fluorescent lamps (CCFLs), a plurality of hot cathode fluorescent lamps (HCFLs), or a plurality of external electrode fluorescent lamps (EEFLs), etc. In particular, the LED backlight source may include a plurality of white LEDs or a plurality of RGB (red, green, blue) LEDs, etc.

The backlight entered from the first light incident surface 900 may propagate inside the light guide plate, and may be outputted at the light emitting surface 930 to illuminate display function materials, such as liquid crystals. Because liquid crystals may not be able to produce light by themselves (unlike for example LED, OLED), liquid crystals may need illumination to display visible images.

In one embodiment, the lateral face may include a second lateral face 920, which may be adjacent to the light emitting surface 930 and opposite to the first light incident surface 900. The reflective microstructures may be disposed on the second lateral face 920. In particular, the second lateral face 920 may only have certain regions disposed with the reflective microstructures. That is, the reflective microstructures may not be continuous disposed on the second lateral face 920.

Further, the first incident surface 900 may include a plurality of third positions 901 (denoted by the dashed lines in FIG. 12), which may exactly face the diodes or lamps in the backlight source. The second lateral face 920 may include a plurality of fourth positions 921, which may correspond to the third positions within the first incident surface 900. For example, the fourth positions at the second lateral face 920 may one-to-one correspond to the third positions at the first incident surface 900. That is, the fourth positions at the second lateral face 920 may exactly face the diodes or lamps in the backlight source. The reflective microstructures may be disposed on the fourth positions 921. It should be noted that, in FIG. 12, the third positions 901 are denoted by the dashed lines for illustrative purposes, which may not be practical structures.

The reflective microstructure may be a dot microstructure. For example, as shown in FIG. 12, the dot microstructure may have a concave shape and the vertex of the concave may be disposed towards the inside of the light guide plate.

In the disclosed embodiments, the reflective microstructures, such as the saw-tooth microstructures, arc-shaped microstructures, and dot microstructures, may be disposed on the second lateral face opposite to the first light incident surface. Meanwhile, the positions of the reflective microstructures (i.e., the fourth positions) may correspond to the positions (i.e., the third positions) on the first light incident surface exactly facing the diodes or lamps in the backlight source.

Thus, when the first light incident surface of the light guide plate has a certain distance away from the second lateral face, the position (i.e., the fourth position) on the second lateral face exactly facing the diodes or lamps in the backlight source may receive more light than the other positions on the second lateral face (i.e., other positions not exactly facing the diodes or lamps in the backlight source). The light incident onto the reflective microstructure disposed at the fourth position may be further scattered and reflected back into the light guide plate. Thus, the light illumination inside the light guide plate may become more uniform. Accordingly, the light outputted at the light emitting surface may be more uniform.

Further, in certain embodiments, at each positions (i.e., the fourth position) on the second lateral face exactly facing the diodes or lamps in the backlight source, the reflective microstructures may be uniformly distributed. In certain other embodiments, at each position (i.e., the fourth position) on the second lateral face exactly facing the diodes or lamps in the backlight source, the reflective microstructures may be non-uniformly distributed.

For example, from the center of the fourth position to the border of the fourth position, the distribution density of the reflective microstructures may gradually increase according to various predetermined algorithms. That is, the distribution density of the reflective microstructures at a certain point within the fourth position may be calculated according to the predetermined algorithms. The predetermined algorithms may be designed according to different applications. For example, from the center of the fourth position to the border of the fourth position, the distribution density of the reflective microstructures may linearly increase, nonlinearly increase, etc.

In certain embodiments, each reflective microstructure may have a same dimension. For example, at the positions (i.e., the fourth positions) on the second lateral face exactly facing the diodes or lamps in the backlight source, the dimension of each reflective microstructure may keep the same, while the gap between two adjacent reflective microstructures may decrease. Thus, from the center of the fourth position to the border of the fourth position, the distribution density of the reflective microstructures may gradually increase.

In certain other embodiments, each reflective microstructure may have a different dimension. For example, from the center of the fourth position to the border of the fourth position, the dimension of each reflective microstructure may change and, meanwhile, the gap between two adjacent reflective microstructures may decrease. For example, from the center of the fourth position to the border of the fourth position, the angular separation between the two planar facets of the saw-tooth or zig-zag microstructure may gradually decrease, the aperture of the concave arc-shaped microstructure may gradually decrease, the aperture of the dot microstructure may gradually decrease, etc.

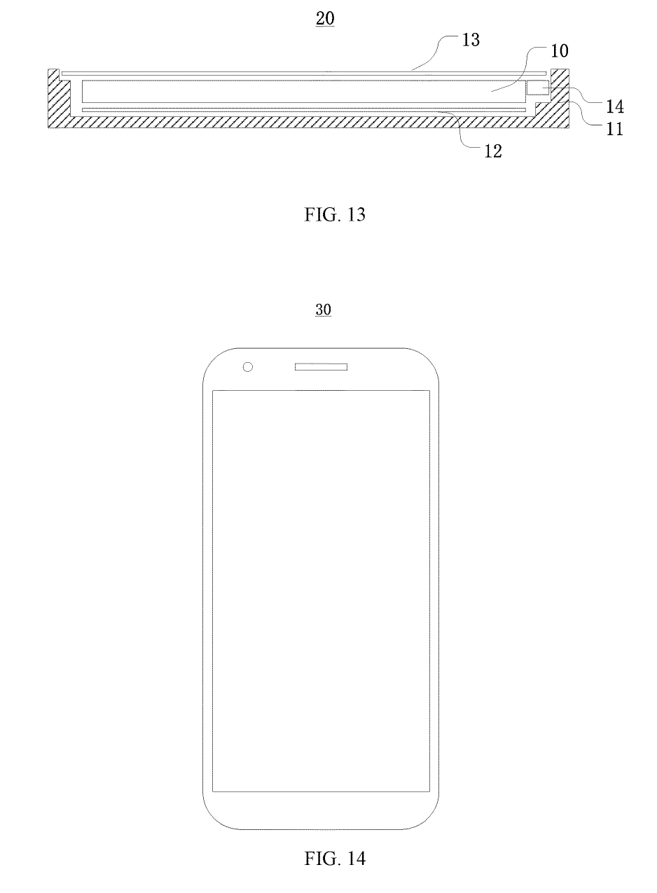

The present disclosure also provides a backlight module, which may include any light guide plate consistent with the disclosed embodiments. FIG. 13 illustrates a cross-sectional view of an exemplary backlight module consistent with disclosed embodiments. As shown in FIG. 13, the backlight module 20 may include a light guide plate 10, a back frame 11, a reflective sheet 12, an optical film 13 and a backlight source 14. In particular, the light guide plate 10 may be any light guide plate consistent with the disclosed embodiments.

The disclosed backlight module may include the disclosed light guide plate, in which reflective microstructures may be disposed on the lateral faces of the light guide plate adjacent to the light emitting surface. The reflective microstructures may be able to improve the backlight efficiency and backlight illumination uniformity. Thus, the disclosed backlight module may have a higher light-emitting efficiency and a more uniform illumination.

The present disclosure also provides a display device, which may include any backlight module consistent with the disclosed embodiments. FIG. 14 illustrates a schematic of an exemplary display device consistent with disclosed embodiments. As shown in FIG. 14, the display device 30 may include any backlight module consistent with the disclosed embodiments. For example, the display device 30 may be a TV, a smartphone, a notebook, and a smartwatch, etc. Further, the display device may be any appropriate type of content-presentation devices including any backlight module consistent with the disclosed embodiments.

Because the disclosed display device may include the disclosed backlight module, which may have a higher light-emitting efficiency and a more uniform illumination, the disclosed display device may exhibit an improved image performance.

In additional of providing a light source to the LCD for displaying images, the disclosed backlight modules may also be employed in some non-LCD products which desire flat light emitting effects. Because of the higher light-emitting efficiency and more uniform illumination, the non-LCD products implemented with the disclosed backlight modules may also exhibit an improved performance.

The description of the disclosed embodiments is provided to illustrate the present disclosure to those skilled in the art. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A light guide plate, comprising:
at least one light incident surface having at least one first light incident surface;
a light emitting surface adjacent to the light incident surface; and
a plurality of lateral faces adjacent to the light emitting surface,
wherein at least one lateral face adjacent to the light emitting surface is disposed with a plurality of reflective microstructures.

2. The light guide plate according to claim 1, wherein:
the reflective microstructure is an optical or electric microstructure reflecting, splitting, scattering, or constraining incident light; and
the reflective microstructure has a dimension in micrometer or sub-micrometer scale.

3. The light guide plate according to claim 2, wherein:
the reflective microstructures is capable of increasing a number of light reflection points at the at least one lateral face and reducing light loss at the at least one lateral face, such that light efficiency is improved.

4. The light guide plate according to claim 3, wherein:
the reflective microstructures is capable of further scattering and reflecting light incident onto the reflective microstructures back into the light guide plate, such that rays inside the light guide plate has an increased distribution density and an increased distribution uniformity.

5. The light guide plate according to claim 4, wherein:
light outputted at the light emitting surface is uniform.

6. The light guide plate according to claim 1, wherein:
the lateral face includes at least one first lateral face adjacent to the first light incident surface and the light emitting surface; and
the plurality of reflective microstructures are disposed on the at least one first lateral face.

7. The light guide plate according to claim 6, wherein:
the lateral face includes two first lateral faces adjacent to the first light incident surface and the light emitting surface; and
the plurality of reflective microstructures are disposed on the two first lateral faces.

8. The light guide plate according to claim 7, wherein each first lateral face further includes:
at least one first position and a second position,
wherein a distribution density of the reflective microstructures at the first position is smaller than a distribution density of the reflective microstructures at the second position.

9. The light guide plate according to claim 8, wherein:
from the first position to the second position, the reflective microstructures are continuously distributed, and the distribution density of the reflective microstructures gradually increases.

10. The light guide plate according to claim 8, wherein:
the first position is at one end of the first lateral face and adjacent to the first light incident surface; and
the second position is at the other end of the first lateral face and away from the first light incident surface.

11. The light guide plate according to claim 8, wherein:
the light incident surface includes a second light incident surface opposite to the first light incident surface,
wherein the first position is at one end of the first lateral face and adjacent to the first light incident surface or adjacent to the second light incident surface, and
the second position has an equal distance to the first light incident surface and the second light incident surface.

12. The light guide plate according to claim 1, wherein the lateral face further includes:
a second lateral face opposite to the first light incident surface, wherein the reflective microstructures are disposed on the second lateral face.

13. The light guide plate according to claim 12, wherein:
the plurality of reflective microstructures are uniformly distributed on the second lateral face.

14. The light guide plate according to claim 12, wherein:
the reflective microstructures are distributed on certain regions of the second lateral face.

15. The light guide plate according to claim 1, wherein:
the reflective microstructure is a wave-shaped groove microstructure or a dot microstructure.

16. The light guide plate according to claim 15 wherein:
the wave-shaped groove microstructure is a saw-tooth microstructure or an arc-shaped microstructure,
wherein the saw-tooth microstructure is disposed towards an inside of the light guide plate, and
the arc-shaped microstructure has a concave shape and a vertex of the concave is disposed towards the inside of the light guide plate.

17. The light guide plate according to claim 15, wherein:
the dot microstructure has a concave shape and a vertex of the concave is disposed towards the inside of the light guide plate.

18. A backlight module, comprising:
a light guide plate;
wherein the light guide plate includes at least one light incident surface having at least one first light incident surface,
a light emitting surface adjacent to the light incident surface, and
a plurality of lateral faces adjacent to the light emitting surface, wherein at least one lateral face adjacent to the light emitting surface is disposed with a plurality of reflective microstructures.

19. A display device, comprising:
a backlight module comprising a light guide plate,
wherein the light guide plate includes at least one light incident surface having at least one first light incident surface,
a light emitting surface adjacent to the light incident surface, and
a plurality of lateral faces adjacent to the light emitting surface, wherein at least one lateral face adjacent to the light emitting surface is disposed with a plurality of reflective microstructures.
